(19) United States
(12) Patent Application Publication
(10) Pub. No.: US 2010/0153463 A1
(43) Pub. Date: Jun. 17, 2010

(54) RUN-TIME DATABASE REDIRECTION SYSTEM

(75) Inventor: Daniel George Heine, Belllevue, WA (US)

Correspondence Address: HONEYWELL/CST;Patent Services, 101 Columbia Road, P.O. Box 2245, Morristown, NJ, 07962-2245, US

(73) Assignee: HONEYWELL INTERNATIONAL INC., Morristown, NJ (US)

(21) Appl. No.: 12/335,483

(22) Filed: Dec. 15, 2008

(51) Int. Cl. G06F 17/30

(52) U.S. Cl. 707/802; 707/E17.125

(57) ABSTRACT

A system for database redirection having a first machine where a database may be partitioned into several sub-schemas. Some of the sub-schemas may be moved to other machines for storage and access according to machine performance, size, availability, location, security technology type, and/or other criteria. Partitioning databases and moving or assigning resulting sub-schemas to the same or other machines may be done at an application start-up or during run-time of the first machine.

### BACKGROUND

The invention pertains to databases and their configurations.

### SUMMARY

The invention is an approach for run-time database redirection for systems such as enterprise building automation systems.

### BRIEF DESCRIPTION OF THE DRAWING

FIGS. 1, 2, 3 and 4 are diagrams of various database configurations;

FIG. 5 is a flow diagram of a database mapping approach;

FIG. 6 is an example database mapping table;

FIG. 7 is a table which showing database path type descriptions;

FIG. 8 is a table showing schema definitions for a database table;

FIG. 9 is a diagram of a re-mappable database schema design of a configuration database;

FIG. 10 is a schematic diagram of a conventional database consolation showing databases that will remain separate and the databases required to be consolidated in the same physical database;

FIG. 11 is a schematic of a database consolidation showing which databases may default to a separate one type of databases, though they may be moved to a server database of the same or another type; and

FIG. 12 is a diagram of an architecture of database operations for sub-schema rearrangement.

### DESCRIPTION

Enterprises need flexible database schemas in order to satisfy the many and varied operational, performance, and corporate IT requirements.

Current systems are relatively inflexible in terms of the database partitioning that is allowable. Once configured, the database schema tends to be fixed and inflexible. As the enterprise grows or needs change, reconfiguring the database schema may be something that is no longer possible without the original developers.

For example, if trendlog data, alarm history data, and operator activity log data are all located in the same database when the installation is designed, splitting these different features out into separate databases as the enterprise grows is not generally possible.

The new database redirection, or “database mapping” feature of the Envision for BACtalk 2.5 System, solves this problem by dividing up the databases into separate “sub-schemas” that can be individually re-mapped at application startup.

This mapping occurs via a “database mapping table”, located in the configuration database, which contains mapping information—for each sub-schema—as to which physical database, server, authentication information, and so on, is to be used for that sub-schema.

For example, the “Alarm History” sub-schema could be located on a server in New York using Microsoft Access/Jet while the “Trendlog” sub-schema could be located on a local server in Chicago using SQL Server.

The definition of which database technology to use and the server/database to use is under the control of the controls engineer designing the specific application for a job site. This is different from current industry offerings in that those decisions are typically in the realm of the software designer rather than the controls engineer or corporate IT specialist.

For each database technology, the application, which defines the partitions as sub-schemas, may contain embedded drivers for that technology that include: 1) Defining the type of the database (such as SQL Server, Microsoft™ Access/Jet, and SQL Lite); 2) Determining the existence of the database; 3) Creating the database; 4) Creating the sub-schema including tables, columns, relationships, and so forth; 5) Upgrading the sub-schema from previous or other versions; 6) Migrating legacy data from previous or other versions; and 7) Backing up certain types of databases.

In addition, the entire application is written on top of a database abstraction layer that is, for the most part, database type-agnostic. This means that the same code that uses SQL Server also works with Microsoft Access/Jet.

Special abstraction classes are used that allow SQL command strings to be generated in the correct format depending on the database technology used.

One of the unique parts of this design is that, for example, the end user or controls engineer can, on any given day decide to move the entire trendlog sub-schema from the SQL Server database in Chicago to an Access database in Miami by simply changing a table entry in the database mapping table and resetting a flag in the configuration file for the application.

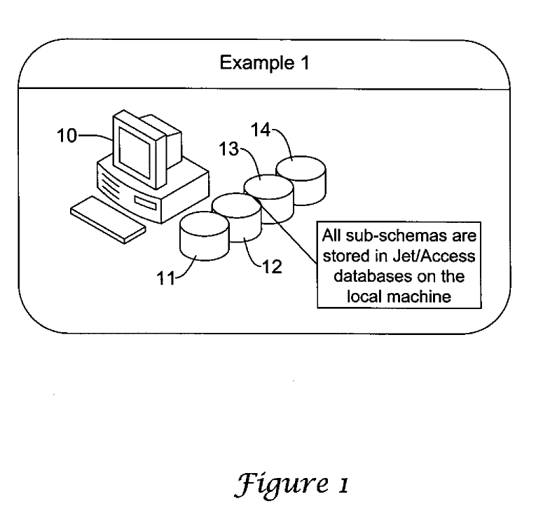

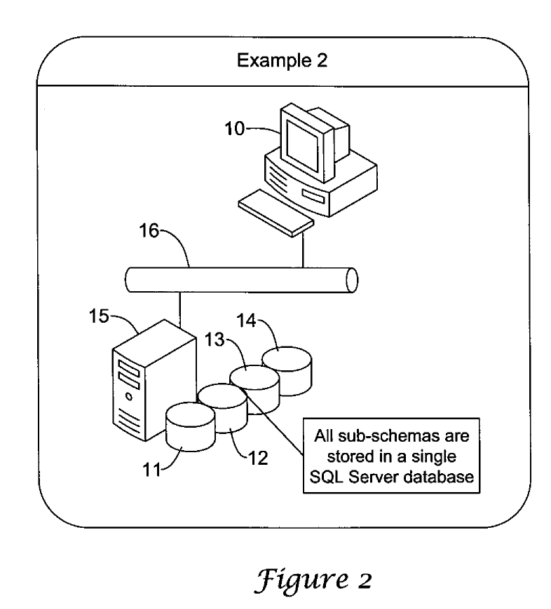

FIGS. 1-4 show various configurations of computer systems for various sub-schemas. An example in FIG. 1 shows a computer or machine 10 with a standard “conventional” configuration having all sub-schemas 11, 12, 13 and 14 stored in Jet/Access databases on a local machine 10. FIG. 2 is a diagram of a standard “enterprise” configuration having a local machine 10 connected to a single SQL server database 15 via a network 16. Sub-schemas 11, 12, 13 and 14 may be stored in the single SQL server database 15.

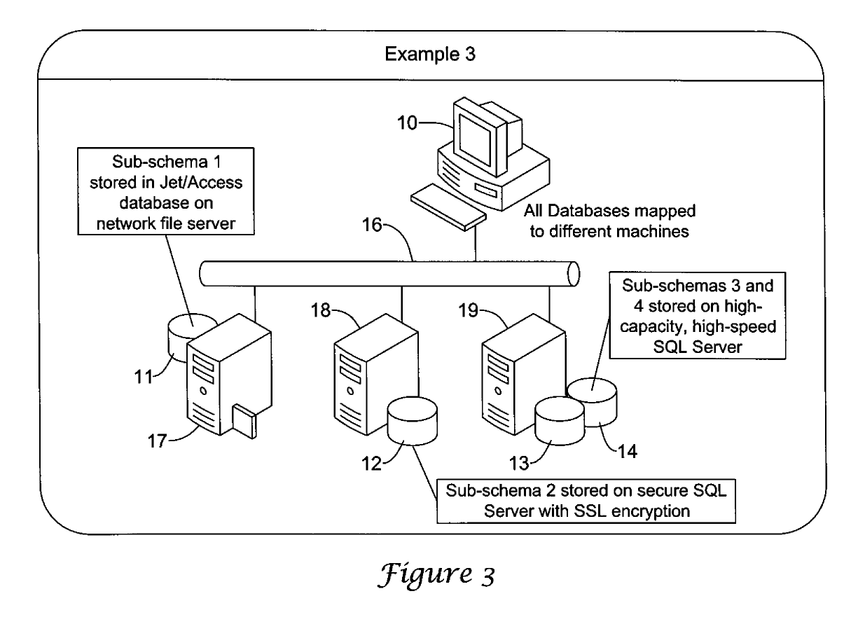

FIG. 3 is a diagram of an example of a mapped “enterprise” configuration (for security and performance). Here, sub-schema 11 may be stored in a Jet/Access data on a network file server 17. Sub-schema 12 may be stored on a secure SQL server 18 with SSL encryption. Sub-schemas 13 and 14 may be stored on a high capacity, high speed SQL server 19. Local machine 10 may be connected to the different servers or machines 17, 18 and 19 via network 16. For one portion of data, there may be a need for quick storage and access which can be accommodated by server 17. Another portion of the data may be needed to be kept secure which can be accommodated by server 18. Still another portion of the data may be voluminous requiring easy and quick storage and access which can be accommodated by server 19.

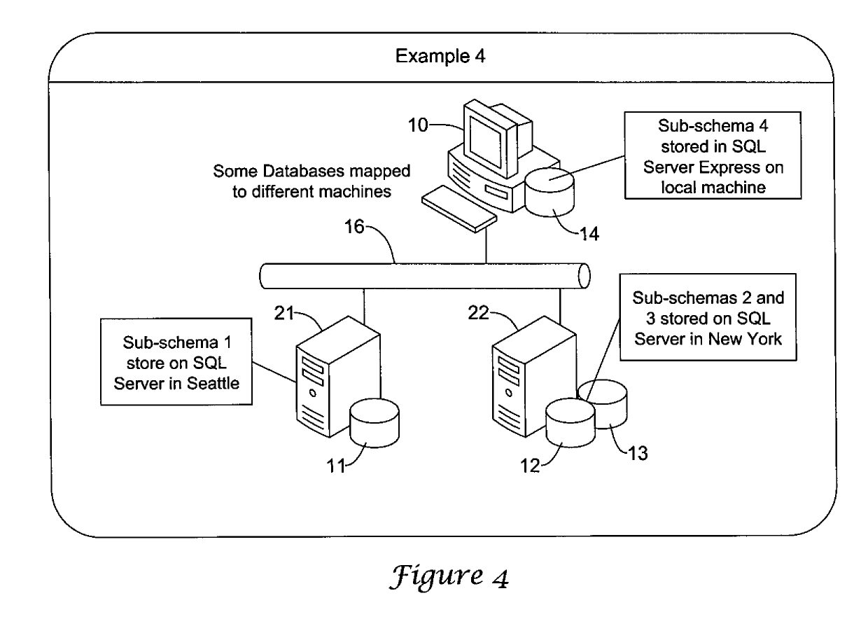

FIG. 4 is a diagram of an example of a mapped “enterprise” (by geography). Here some of the databases may be mapped to different machines. Sub-schema 14 may be stored in a SQL Server Express database on the local machine 10. Sub-schema 11 may be stored in an SQL Server database 21 in Seattle. Sub-schemas 12 and 13 may be stored in a SQL Server database 22 in New York.

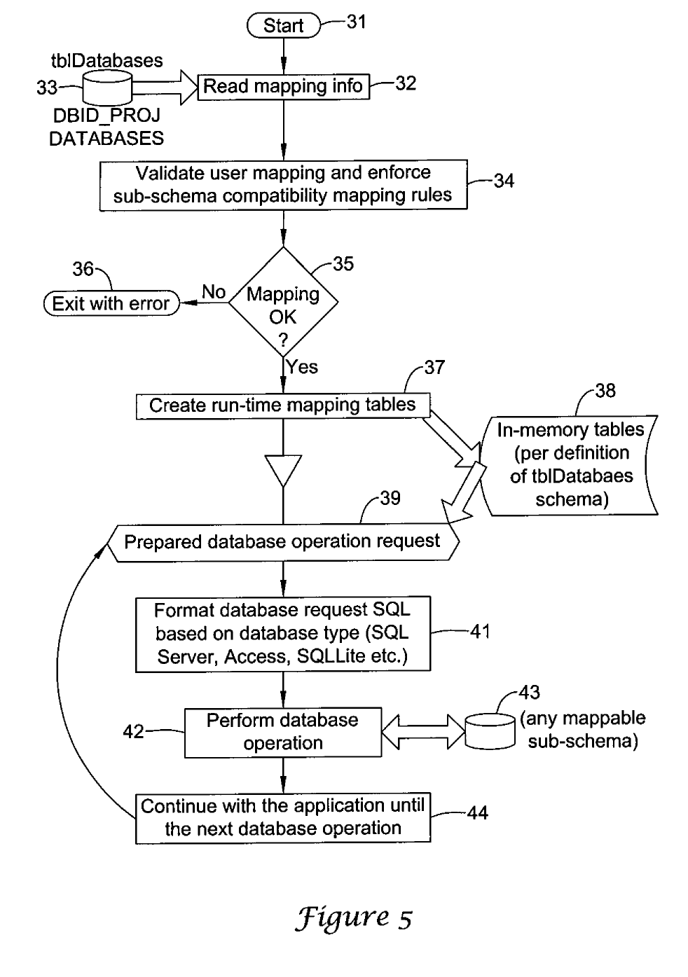

FIG. 5 is a flow diagram of an example approach of database mapping. The approach may go from a start 31 to reading mapping information at block 32 from tblDatabases (DBID_PROJDATABASES), i.e., sub-schema, at symbol 33. User mapping may be validated and the sub-schema compatibility mapping rules may be enforced at block 34. At symbol 35, the mapping may be checked for acceptability. If unacceptable, then there may be an exit with error at symbol 36. If acceptable, then run-time mapping tables may be created at block 37. Tables (per definition of tblDatabases schema) may be stored in memory 38. A database operation may be prepared at symbol 39. Tables may be taken from memory 38 to the database operation request 39. The database request SQL may be formatted based on a selected database type (e.g., SQL server, Access, SQL Lite, and so forth) at block 41. Then a database operation may be performed at block 42. The database operation may be performed with virtually any mappable sub-schema 43. At block 44, the application may be continued until the next database operation at symbol 39.

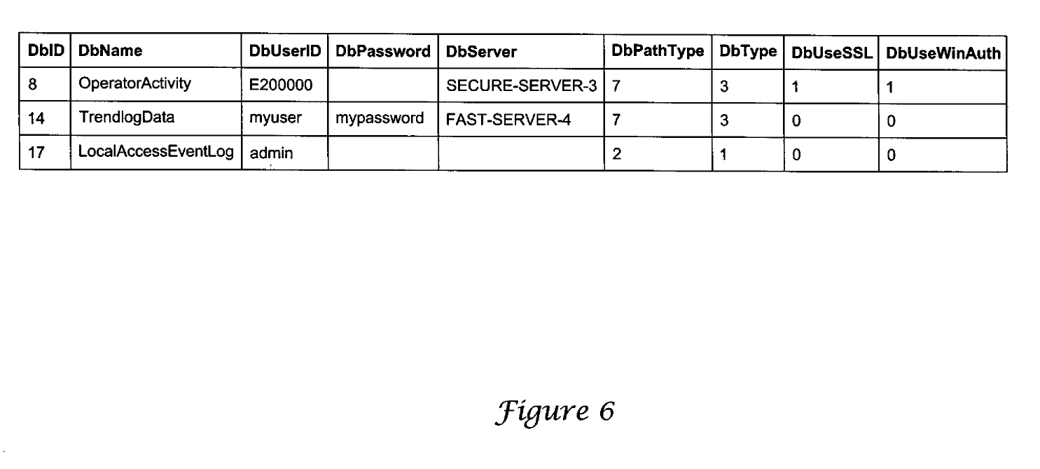

FIG. 6 shows an example database mapping table (tblDatabases) with 3 rows that re-map DBID 8 (DBID_OPERACT), DBID 14 (DBID_TRENDLOGDATA), and DBID 17 (DBID_EVENTLOG). This is an example of what you might find in the database mapping table (tblDatabases) for a job that requires very secure Operator Activity log data, very fast trendlog data storage, and where the Event log needs to be an Access database on the local hard drive. This can be configured by the engineering designing the job (using an Alerton EBT™ tool referred to herein) to meet the customer's security and performance requirements.

In this example, the operator activity sub-schema (DBID=8) is re-mapped to a SQL Server (DbType=3) machine (named SECURE-SERVER-3) and uses SSL encryption for all communications with that server. The user ID that is used for login is “E200000” and the password is provided by Windows using Windows Authentication. The real-time trendlog data (DBID=14) is logged to a very fast and high-capacity server named FAST-SERVER-4. Event log data (DBID=17) is re-mapped back to a local Access database (DbType=1) named “LocalAccessEventlog.mdb” in the local job directory (DbPathType=2). It may use the standard “admin” user for the Jet/Access database.

Background information is provided herein to help in interpreting the mapping table example in FIG. 6. Source code comments and definitions for the database mapping table may be noted. The configuration database may be noted as ProjectDatabases. This sub-schema may be used to store the database sub-schema mapping information that allows sub-schemas (DBID_*) to be mapped to different physical databases. As an example, enterprise jobs may have the DBID_PROJDATABASES set to use SQL Server. This may be done in a static mapping table that is part of the code.

| | |
|---|---|
| */ | |
| #define DBF_PROJDATABASES | “ProjectDatabases.mdb” |
| /* Table: Databases | |
| */ | |
| #define TBL_DATABASES | “tblDatabases” |
| /* Table TBL_DATABASES columns. | |
| * | |

```
  * DbName is the logical database name (no file extension).
  * DbPath is the path name, including file
  * extension (e.g., “Alarms.mdb” or “Alarms.mdf”).
  */
```

| | | |
|---|---|---|
| #define FLD_DATABASES_DB_ID | “DbID” | // Pre-defined integer ID for this |
| database | | |
| #define FLD_DATABASES_DB_NAME | “DbName” | // Database name (no file |
| extension) | | |
| #define FLD_DATABASES_DB_USERID | “DbUserID” | // Login user (optional) |
| #define FLD_DATABASES_DB_PASSWORD | “DbPassword” | // Password (optional) |
| #define FLD_DATABASES_DB_SERVER | “DbServer” | // Database server instance |
| (optional) | | |
| #define FLD_DATABASES_DB_PATH_TYPE | “DbPathType” | // See DbPathType definition below |
| #define FLD_DATABASES_DB_TYPE | “DbType” | // 1 = Jet/Access, 2 = SQLite, 3 = |
| SQL Server | | |
| #define FLD_DATABASES_DB_USE_SSL | “DbUseSSL” | // Use SSL encryption |
| #define FLD_DATABASES_DB_USE_WINAUTH | “DbUseWinAuth” | // Use Windows authentication for |
| login | | |

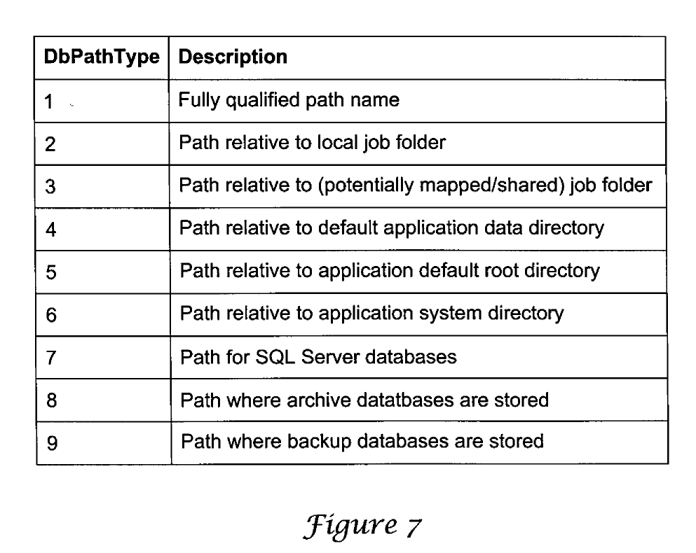

FIG. 7 is a table which reveals (database) DbPathType definitions or descriptions. The definitions are examples which may be used. Other definitions may be provided. Data path type (DbPathType) 1 may be a fully qualified path name. Type 2 may be a path relative to local job folder. Type 3 may be a path relative to (potentially mapped/shared) job folder. Type 4 may be a path relative to default application data directory. Type 5 may be a path relative to application default root directory. Type 6 may be a path relative to application system directory. Type 7 may be a path for SQL Server databases. Type 8 may be a path where archive databases are stored. Type 9 may be a path where backup databases are stored.

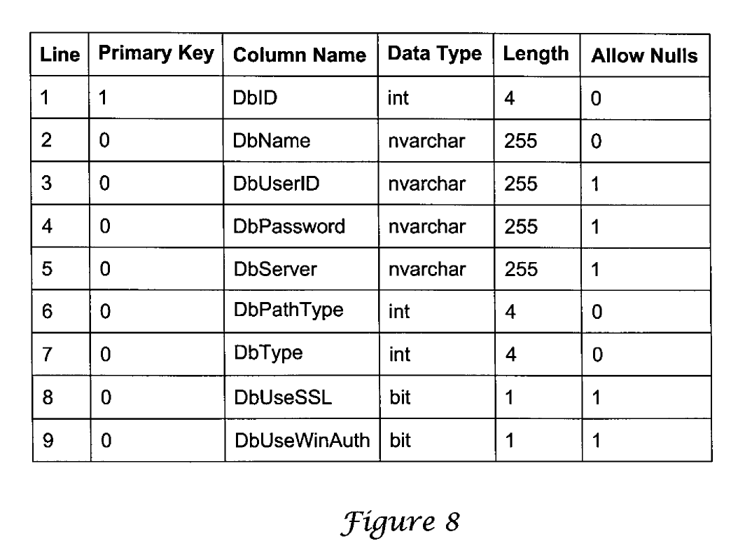

FIG. 8 is a table showing schema definitions for tblDatabases (contained in DBID_PROJDATABASES). They are displayed according to columns of primary key, column name, data type, length, and allow nulls, respectively, and indexed according to line. Line 1 shows a primary key of 1, column name of DbID, data type of int, length of 4, and allow nulls of 0. Line 2 shows a primary key of 0, column name of DbName, data type of nvarchar, length of 255, and allow nulls of 0. Line 3 shows a primary key of 0, column name of DbUserID, data type of nvarchar, length of 255, and allow nulls of 1. Line 4 shows a primary key of 0, column name of DbPassword, data type of nvarchar, length of 255, and allow nulls of 1. Line 5 shows a primary key of 0, column name of DbServer, data type of nvarchar, length of 255, and allow nulls of 1. Line 6 shows a primary key of 0, column name of DbPathType, data type of int, length of 4, and allow nulls of 0. Line 7 shows a primary key of 1, column name of DbType, data type of int, length of 4, and allow nulls of 0. Line 8 shows a primary key of 0, column name of DbUseSSL, data type of bit, length of 1, and allow nulls of 1. Line 9 shows a primary key of 0, column name of DbUseWinAuth, data type of bit, length of 1, and allow nulls of 1.

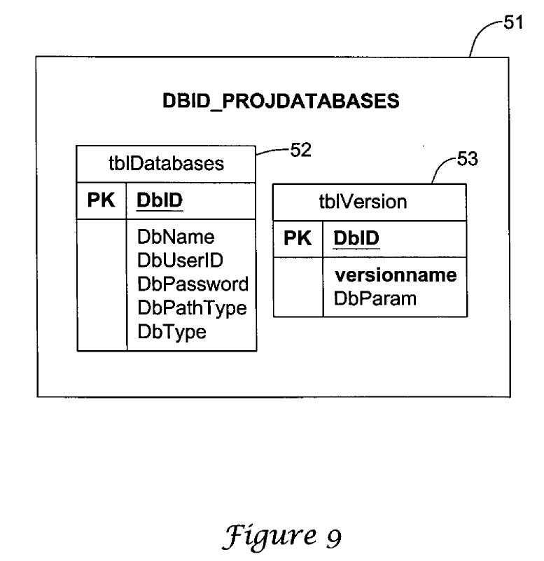

FIG. 9 is a diagram of a re-mappable database schema design 51 of DBID_PROJDATABASES. Tables 52 and 53 show tblDatabases and tblVersion. The DbID's shown in table 52 are DbName, DbUserID, DbPassword, DbPathType and DbType. The DbID shown in version table 53 is version name DbParam.

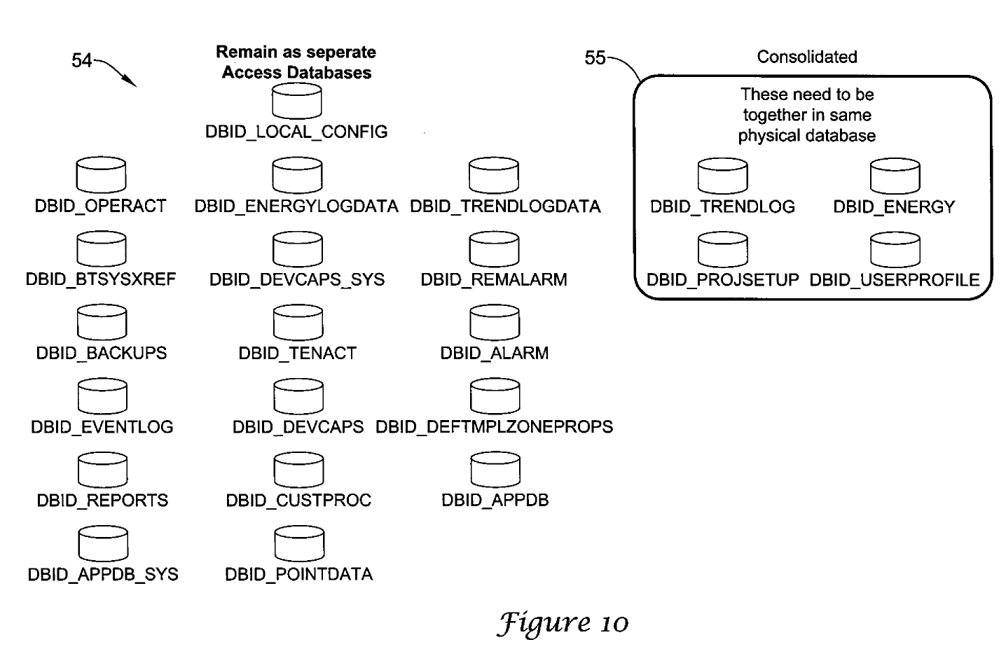

FIG. 10 is a schematic diagram 54 of a conventional database consolation showing databases that will remain as separate Access databases. Some databases, such as DBID_TRENDLOG, DBID_ENERGY, DBID_PROJSETUP and DBID_USERPROFILE databases, need to be kept together as group 55 in the same physical database. The DBID_PROJDATABASES database is not to be used for a conventional server.

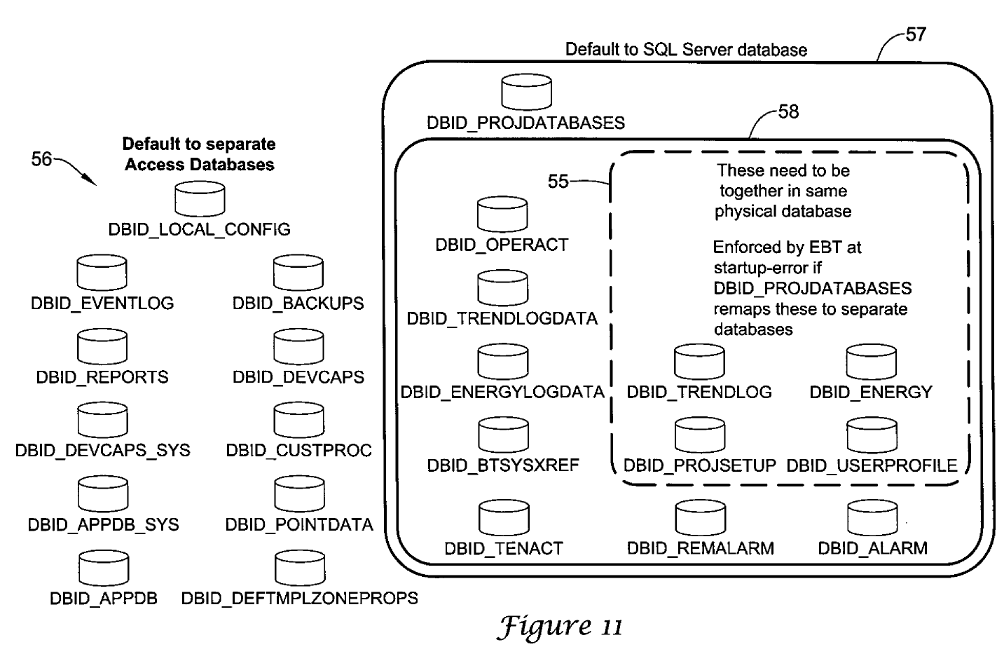

FIG. 11 is a schematic 56 of an enterprise database consolidation showing databases which may default to separate Access databases, though they may be moved to other server databases of the same or another type. A group 57 of databases may be default to an SQL server database but may be moved to other server databases of the same or another type. The DBID_PROJDATABASES may (optionally) remap virtually all databases, particularly of group 58, between Access and SQL servers by a sub-schema ID. Within group 58 may be a set 55 of databases, as also shown in FIG. 10, that need to be kept together in the same physical database. The keeping together of set 55 is to be enforced by EBT at startup and an error will be noted if the DBID_PROJDATABASES database remaps one or more databases apart from one another to separate physical databases.

Sub-schema versus database may be noted. DBID's may represent sub-schemas. There may be one or more sub-schemas per database. For example, one SQL Server database may have several sub-schemas in it (such as DBID_PROJSETUP, DBID_USERPROFILE, and so forth). Each sub-schema (DBID) present in the database may have its row in the version table (FIG. 9). The version table may reflect the version of each sub-schema in the database.

Re-mapping databases may be noted as the following. The DBID_PROJDATABASES sub-schema allows remapping of sub-schemas to different databases (i.e., mix′ n′ match within certain limits). The re-mapping may allow for SQL server performance optimization. Each time a new ADO (ActiveX Data Objects) connection is opened, it may be checked against cached data from a TBL_DATABASES table in the DBID_PROJDATABASES to see where the database actually resides and what type of database it is. The TBL_DATABASES cache may be initialized when the EBT is started. Subsequent changes to TBL_DATABASES generally will be ignored until the next time that the EBT is started. Internal tables may be initialized from TBL_DATABASES when the EBT starts up. Subsequent changes to the TBL_DATABASES will have no effect until the EBT restarts.

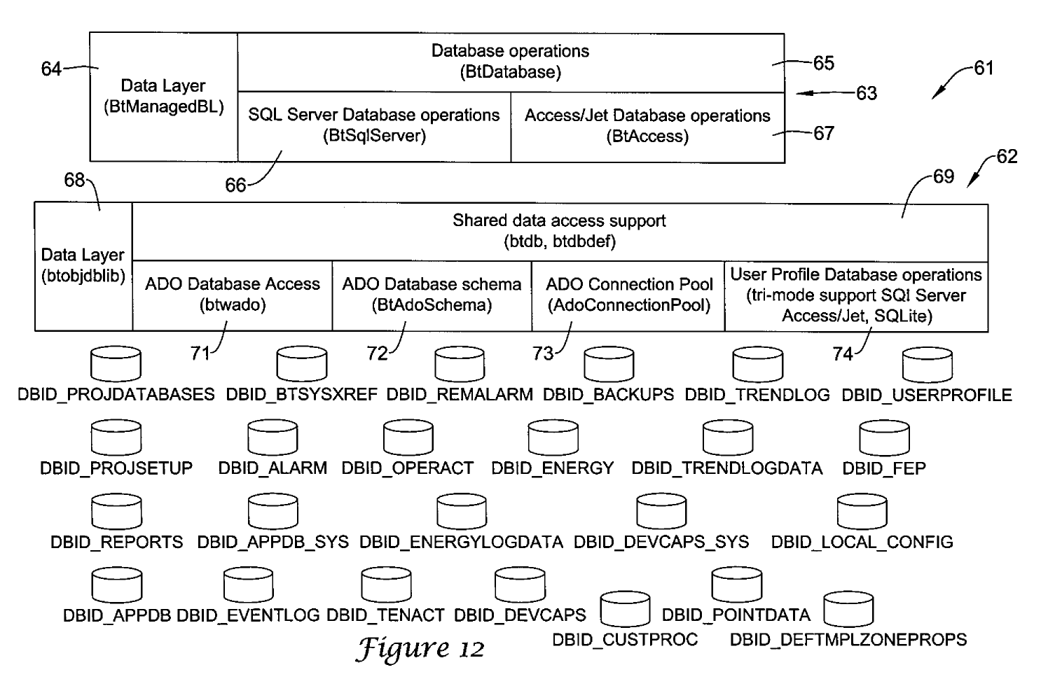

FIG. 12 is a diagram of an architecture 61 of the database operations. Over the databases is a layer 62 which is an ADO abstraction layer on which an application may be written. Another abstraction layer 63 may put on the layer 62. This permits a defining of additional characteristics about the database and in particular the mapping table. Differences between the databases may be abstracted out. It may be decided at runtime where the database is, what type, its underlying technology, and so on. The top ADO layer is database agnostic.

Block or layer 63 is an enterprise layer and block or layer 62 is a common data layer. Layer 63 indicates a data layer 64 (BtManagedBL) and database operations 65 (BtDatabase). Under operations 65 are SQL Server database operations 66 (BtSqlServer) and Access/Jet database operations 67.

Under layer 63 is layer 62 which indicates a data layer 68 (btobjdblib) and a shared data access support layer 69 (btdb, btdbdef). Under support layer are an ADO database access 71 (btwado), ADO database schema 72 (BtAdoSchema), ADO connection pool 73 (AdoConnectionPool), and user profile database operations 74 (tri-mode support: SQL Server, Access/Jet, SQL Lite).

Databases may be opened and closed. An IBTAdoConnectionPtr class may exist in EBT, encapsulate ADO connection and associated operations and can specify a database using a BACtalk connection handle, database ID and an optional parameter. The parameter can represent a device instance for PointData, trendlog ID for trendlog data, or an energy log number for virtually every log data. The class may also allow sharing an ADO connection with IBtAdoSchema object, and automatically close (or cache) a database connection when the IBTAdoConnectionPtr object goes out of scope.

Creating tables, fields and indexes may be noted. The IBtAdoSchema class may act as an interface class to abstract the SQL server and access classes (BtAdoSchemaBase, BtJetSchema, and BtMsSqlSchema) that implement their respective operations. The class may now be an abstract class representing either SQL server or Jet schema capability, for example, depending on the database type. The IBtAdoSchema class may permit creation of tables, fields, indexes, and so on. For SQL server clean, a CSQLString may provide an ability to parameterize to a database at runtime without a need of hard code. Proper syntax may be provided at runtime. The database mapping table is a key to runtime applying of databases to different localities. The table may configured by a user to meet certain needs. An application may be a breakup or a partition of a database into sub-schemas. Sub-schemas may be abstracted out with the database mapping table. Several things can drive a partition of a database into schemas. Scalability with partitioning may allow growing a database beyond its original size and its components for holding the database. Partitioning may enable encryption for some portions of the database and not for other portions. Partitioning may let a user to put a portion of a database in a certain database server type, such as Access/Jet, for a third party such as a customer to use, but prevent the party from having access to the remaining portion or portions of the database. Partitioning a database into sub-schemas permits certain data to be on a high bandwidth server database and other data to be on a less expensive low bandwidth server database.

To recap, the invention is a system for database redirection, having a first machine, a database stored on the first machine and a mechanism for partitioning the database into sub-schemas and moving one or more sub-schemas to be stored at one or more other machines, such as at another location external to the first machine. A machine may be a computer, server, or the like. Partitioning and moving may be effected by a user according to application design of a task to be performed with the first machine. Partitioning the database and moving the one or more sub-schemas may occur during run-time of the first machine. Partitioning and/or moving may be done over a network.

At one or more sub-schemas on the first machine may be stored as a first type of database. One or more sub-schemas may be stored as another type of database on the same or another machine.

A configuration database may be stored on the first machine. A database mapping table, for containing mapping information for each sub-schema, may be situated in the configuration database. Mapping information for a sub-schema can be entered in the configuration database via the database mapping table. Partitioning and moving sub-schemas may be effected by making entries in the database mapping table. The mapping information may be entered before or at an application start-up.

The partitioning the database into sub-schema may be according to one or more criteria. These criteria may include performance, capacity or size, availability, location, security, technology type, and other properties. A sub-schema may be moved to and stored at a machine according to or meeting the one or more criteria designated for the respective sub-schema. Some technology types may include SQL, Jet/Access, SQL Lite, and other types.

The database mapping table may have at least one entry selected from a group of items containing a sub-schema ID, a database name, a password, a server, a path type, a technology type, encryption use, authentication, and/or other entry.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A system for database redirection for enterprise building automation, comprising:
a first machine;
an enterprise building automation database stored on the first machine; and
a mechanism for partitioning the database into sub-schemas and moving at least one sub-schema to be stored on a second machine.

2. The system of claim 1, wherein the partitioning the database and the moving at least one sub-schema occurs during run-time of the first machine.

3. The system of claim 1, wherein:
at least one sub-schema on the first machine is stored as a first type of database; and
at least one sub-schema is stored as a second type of database.

4. The system of claim 1, wherein:
a configuration database is stored on the first machine;
a database mapping table is situated in the configuration database; and
the database mapping table is for containing mapping information for each sub-schema.

5. The system of claim 4, wherein mapping information for a sub-schema can be entered in the configuration database via the database mapping table.

6. The system of claim 5, wherein mapping information for a sub-schema can be entered before or at an application start-up.

7. The system of claim 1, wherein:
the partitioning the database into sub-schema is according to one or more criteria; and
the criteria comprise:
performance;
size;
availability;
location;
security; and
technology type; and
a sub-schema is stored at a machine meeting the one or more criteria designated for the respective sub-schema.

8. The system of claim 7, wherein technology types comprise:
SQL;
Jet/Access;
SQL Lite; and
other types.

9. The system of claim 4, wherein the database mapping table comprises at least one entry selected from a group containing a sub-schema ID, a database name, a password, a server, a path type, a technology type, encryption use, authentication, and/or other entry.

10. A method for database redirection for an enterprise building automation system, comprising:
partitioning an enterprise building automation database into sub-schemas at a first machine; and
moving at least one sub-schema to a second machine.

11. The method of claim 10, wherein:
a sub-schema is of a first database technology at the first machine; and
the at least one sub-schema is of the first or a second database technology at the second machine.

12. The method of claim 10, wherein the moving of the at least one sub-schema is over a network.

13. The method of claim 10, wherein the partitioning and moving is effected by making entries in a database mapping table.

14. The method of claim 13, wherein the database mapping table is a part of a configuration database at the first machine.

15. The method of claim 13, wherein the database mapping table contains mapping information for each sub-schema.

16. The method of claim 10, further comprising:
assigning one or more criteria to each sub-schema; and
wherein the criteria comprise:
machine type;
machine capacity;
machine performance;
machine security; and
machine location, and
each sub-schema is moved to or kept at a machine meeting the one or more criteria assigned to the respective sub-schema.

17. An enterprise building automation database sub-schema system comprising:
a enterprise building automation database situated in a first machine; and
a configuration mechanism connected to the first machine; and
wherein the configuration mechanism is for partitioning the database into two or more sub-schemas, and moving one or more sub-schemas to be stored at one or more machines external to the first machine.

18. The system of claim 17, wherein:
the configuration mechanism comprises a database mapping table; and
the database mapping table is for indicating information about the two or more sub-schemas from the database.

19. The system of claim 18, wherein moving the two or more sub-schemas is effected by making entries in the database mapping table.

20. The system of claim 19, wherein:
the one or more sub-schemas are moved according to one or more features of the one or more machines where the two or more sub-schemas are to be stored; and
the features comprise performance, capacity, security, location, technology type, location, and other desired attributes for storage of the one or more sub-schemas.

21. The system of claim 20, wherein the partitioning and moving is effected by a user according to application design of a task to be performed by the first machine.
